(19) United States
(12) Patent Application Publication
(10) Pub. No.: US 2025/0242797 A1
(43) Pub. Date: Jul. 31, 2025

(54) WHEEL SPEED SENSOR NOISE FILTERING

(71) Applicant: GM Global Technology Operations LLC, Detroit, MI (US)

(72) Inventors: Ami Woo, Calgary (CA); Mohammadali Shahriari, Markham (CA); Dhaval K. Sompura, Canton, MI (US); Ashraf Abualfellat, Grand Blanc, MI (US); Daniel J. Cornelius, Detroit, MI (US)

(73) Assignee: GM GLOBAL TECHNOLOGY OPERATIONS LLC, Detroit, MI (US)

(21) Appl. No.: 18/423,598

(22) Filed: Jan. 26, 2024

(51) Int. Cl. B60W 30/02

(52) U.S. Cl. CPC B60W 30/02; B60W 2520/28; B60W 2756/10

(57) ABSTRACT

Noise filtering for a wheel speed or other sensor, such as a wheel speed sensor configured for sensing rotational speed of a wheel included onboard a vehicle. A filtering process may include determining sensor data generated with the wheel speed sensor, the sensor data representing rotational speed of the wheel, determining a steady interval of wheel rotation and a non-steady interval of wheel rotation, and filtering noise from the sensor data associated with the steady interval according to an adaptive filtering process.

### INTRODUCTION

The present disclosure relates to noise filtering, such as but not necessarily limited to noise filtering for a wheel speed sensor included onboard a vehicle to measure wheel rotation.

A vehicle may include a plurality of wheels to facilitate movement, generally with one or more of the wheels being undriven and/or one more of the wheels being driven. The undriven wheels may correspond with those configured to passively rotate according to movement of the vehicle, and the driven wheels may correspond with those configured to be driven or mechanically rotated for purposes of propelling the vehicle. A vehicle may include a wide variety of vehicle systems to facilitate its operation, including those that may be reliant upon or otherwise influenced by having an accurate and precise representation of wheel speed. An advanced driving assistant system (ADAS), for example, may be one such system whereby its capability to operate as desired may be at least partially based on accurately and precisely ascertaining wheel speed. A vehicle may include wheel speed sensors to facilitate measuring wheel speed, rotation, acceleration, etc., however, due to differing road conditions, manufacturing variabilities, and other inherent or induced inconsistencies, the wheel speed sensors may periodically provide differing or varying speed values, and in some cases, differing values when the wheels may be rotating at relatively the same speed. While contrasting road conditions, differing suppliers, inconsistent calibration, and other discrepancies may result in some of the wheels periodically rotating at differing speeds, one prevalent source of inconsistency may result from noise within sensor data collected with the wheel sensors, i.e., unwanted or extraneous variations in the sensor data that may not be directly related to actual motion or rotation of the attendant wheel.

### SUMMARY

One non-limiting aspect of the present disclosure relates to filtering noise for wheel speed sensors, such as to minimize or otherwise ameliorate variances resulting from unwanted or extraneous variations in the sensor data that may not be directly related to actual motion or rotation of a sensed wheel. The noise filtering may be provided in an adaptive manner, optionally on a wheel-by-wheel basis, so as to increase and/or decrease levels of noise filtering as needed to compensate for variances that may be present or more pronounced at some wheel sensors than others. The capability to filter out, attenuate, or otherwise compensate for the noise may be beneficial in providing more accurate and precise measurements, which may in turn be particularly valuable in optimizing operation of vehicle systems reliant upon or otherwise influenced by having suitable representations of wheel speed.

One aspect of the present disclosure relates to a method of filtering noise for a wheel speed sensor configured for sensing rotational speed of a wheel included onboard a vehicle. The method may include determining sensor data generated with the wheel speed sensor, the sensor data representing rotational speed of the wheel, determining a steady interval of wheel rotation and a non-steady interval of wheel rotation, optionally with the steady interval corresponding with the wheel rotating at a steady state and the non-steady interval corresponding with the wheel rotating at a non-steady state, and filtering noise from the sensor data associated with the steady interval according to an adaptive filtering process.

The method may include performing the adaptive filtering process based on a variability calculation generating a noise value to represent an amount of noise within the sensor data associated therewith.

The method may include performing a filter selection process to select a noise filter for the adaptive filtering process from a plurality of available filters based on the noise value.

The method may include the filter selection process including cross-referencing the noise value relative to a filter selection graph to determine the noise filter, optionally with the filter selection graph delineating the available filters relative to a plurality of possible noise values.

The method may include selecting the noise filter to correspond with a one of the available filters cross-referenced with a related one of the possible noise values most closely aligned with the noise value.

The method may include the available filters corresponding with a plurality of low-pass filters arranged in the filter selection graph such that a lowest frequency filter of the low-pass filters corresponds with a lowest one of the possible noise values and a highest frequency filter of the low-pass filters corresponds with a highest one of the possible noise values.

The method may include the available filters in the filter graph being dispersed in a linear manner between the lowest frequency filter and the highest frequency filter.

The method may include filtering noise from the sensor data associated with the non-steady interval according to a non-adaptive filtering process, optionally with the non-adaptive filtering process including filtering noise from the sensor data using a static filter.

The method may include selecting the static filter from a look-up table configured for cross-referencing a plurality of speed based filters relative to a vehicle speed of the vehicle, the static filter corresponding with a one of the speed based filters most closely aligned with the vehicle speed associated with the sensor data being filtered.

The method may include determining the steady and non-steady intervals according to a variability process, optionally with the variability processing determining the steady interval to coincide with the sensor data indicating speed variances in the wheel rotation to be within a steady range.

The method may include determining the wheel rotation to be within the steady range based on a two-factor authentication process. The two-factor authentication process may include assessing the speed variances to be within the steady range in response to the sensor data associated therewith separately passing both of a shorter window aggregation assessment and a longer window aggregation assessment.

The method may include determining the shorter window aggregation assessment to be passed in response to the sensor data indicating the speed variances occurring throughout a shorter sampling window to be less than a first threshold.

The method may include determining the longer window aggregation assessment to be passed in response to the sensor data indicating the speed variances occurring throughout a longer sampling window to be less than a second threshold, wherein the longer sampling window is larger than the shorter sampling window.

One aspect of the present disclosure relates to a computer-readable storage medium having a plurality of non-transitory instructions stored thereon, which, when executed with one or more processors, are operable for filtering noise of a wheel speed sensor configured for sensing rotational speed of a wheel included onboard a vehicle. The non-transitory instructions may be operable for determining sensor data generated for representing rotational speed of the wheel, determining a steady interval of wheel rotation and a non-steady interval of wheel rotation, optionally with the steady interval corresponding with the wheel rotating at a steady state and the non-steady interval corresponding with the wheel rotating at a non-steady state, characterizing the sensor data associated with the steady interval as steady-state sensor data and the sensor data associated with the non-steady interval as non-steady-state sensor data, generating a steady-state noise characterization for the steady-state sensor data, selecting a noise filter from a plurality of available filters based on the steady-state noise characterization, and filtering noise from the steady-state sensor data according to an adaptive filtering process.

The non-transitory instructions may be operable for determining the steady-state noise characterization based on a variability calculation configured for characterizing an amount of noise within the sensor data according to a standard deviation thereof.

The non-transitory instructions may be operable for selecting the noise filter from a filter selection graph configured for delineating the available filters relative to a plurality of possible steady-state noise characterizations, including selecting the noise filter to correspond with the available filter cross-referenced with the steady-state noise characterization most closely aligned with the standard deviation.

The non-transitory instructions may be operable for selecting the noise filter to correspond with one of a plurality of low-pass filters arranged in the filter selection graph in a linear manner from a lowest frequency low-pass filter to a highest frequency low-pass filter with a plurality of intermediary low-pass filters therebetween.

One aspect of the present disclosure relates to a vehicle. The vehicle may include a plurality of wheels operable to facilitate movement of the vehicle, a powertrain operable to rotate one or more of the wheels in response to mechanical power generated with an internal combustion engine and/or an electric motor, a plurality of wheel sensors configured for generating sensor data to represent the rotational speed of the wheel associated therewith, and a noise filter controller configured for adaptively filtering noise from the sensor data using a noise filter individually selected for each of the wheel sensors from a plurality of available filters, wherein the noise filter controller may be configured for selecting the noise filters based on a noise characterization for the wheel sensor associated therewith.

The available filters may include a plurality of low-pass filters configured for low-pass filtering according to differing ones of a plurality of filter frequencies. The noise filter control may be configured for selecting the noise filters to correspond with the low-pass filter most closely aligned with the noise characterization of the wheel sensor associated therewith.

The vehicle may include the low-pass filters arranged in a filter selection graph in a linear manner relative to the noise characterizations from a lowest frequency low-pass filter to a highest frequency low-pass filter with a plurality of intermediary low-pass filters therebetween.

These features and advantages, along with other features and advantages of the present teachings, may be readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which may be incorporated into and constitute a part of this specification, illustrate implementations of the disclosure and together with the description, serve to explain the principles of the disclosure.

FIG. 1 illustrates a vehicle having wheel sensors in accordance with one aspect of the present disclosure.

FIG. 2 illustrates unfiltered wheel sensor data in accordance with one aspect of the present disclosure.

FIG. 3 illustrates filtered wheel sensor data in accordance with one aspect of the present disclosure.

FIG. 4 illustrates a flowchart of a method for filtering noise in accordance with one aspect of the present disclosure.

FIG. 5 illustrates a graph of sampling unfiltered wheel sensor data in accordance with one aspect of the present disclosure.

FIG. 6 illustrates a graph of noise filters in accordance with one non-limiting aspect of the present disclosure.

### DETAILED DESCRIPTION

As required, detailed embodiments of the present disclosure may be disclosed herein; however, it may be understood that the disclosed embodiments may be merely exemplary of the disclosure that may be embodied in various and alternative forms. The figures may not be necessarily to scale; some features may be exaggerated or minimized to show details of particular components. Therefore, specific structural and functional details disclosed herein may need not to be interpreted as limiting, but merely as a representative basis for teaching one skilled in the art to variously employ the present disclosure.

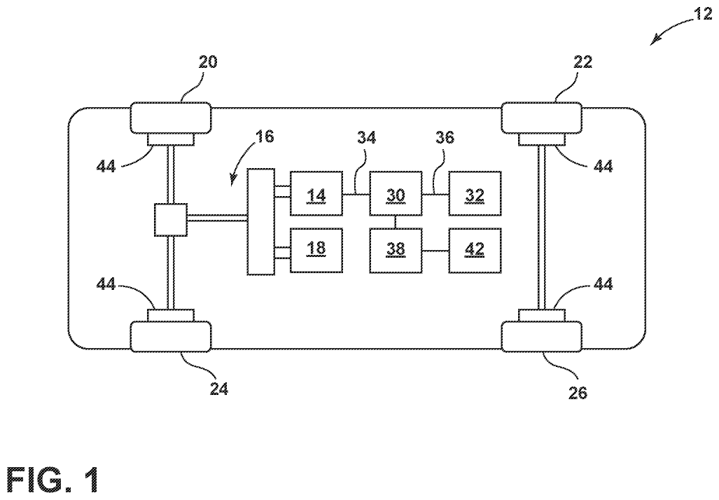

FIG. 1 illustrates a vehicle 12 in accordance with one non-limiting aspect of the present disclosure. The vehicle 12 may include an electric, traction motor 14 operable for converting electrical power to mechanical power for purposes of performing work, such as for mechanically powering a drivetrain 16 to propel the vehicle. The vehicle 12 is illustrated as a hybrid type due to the powertrain 16 optionally including an internal combustion engine (ICE) 18 for generating mechanical power. The vehicle 12 may alternatively omit the electric motor 14 and instead be solely propelled with the ICE 18. The powertrain 16 may include componentry to facilitate conveying mechanical, rotative force from the traction motor 14 and/or the ICE 18 to one or more of the wheels 20, 22, 24, 26. The vehicle 12 may include a rechargeable energy storage system (RESS) 30 to store and supply electrical power for the traction motor 14 and/or other components, systems, etc. 32 onboard the vehicle 12, such as via a first bus 34 (e.g., main or HV bus) and a second bus 36 (e.g., auxiliary or LV bus). The vehicle 12 may include a vehicle controller 38 to facilitate monitoring, controlling, measuring, and otherwise directing operation, performance, etc. onboard the vehicle 12, which may include performing measurements, taking readings, or otherwise collecting data to facilitate operations. The vehicle controller 38 may include additional controllers, with the operations associated therewith optionally being undertaken according to one or more processors executing corresponding non-transitory instructions stored on one or more computer-readable storage mediums.

One non-limiting aspect of the present disclosure relates to the vehicle controller 38 including and/or being operational with a noise filter controller 42. The noise filter controller 42 may be configured for filtering noise for a plurality of wheel speed sensors 44 included onboard the vehicle to sense, measure, record, or otherwise assess rotational speed or other movement of the wheels. The noise filter controller 42 may be configured to filter out noise from sensor data being collected with the speed sensors 44, which may include assessing acceleration, angular position, rotation, and/or or other aspects associated with use of the wheels, which for the sake of presentation simplicity and brevity may be collectively referred to as rotational or wheel speed. The noise filter controller 42 may be operable for filtering noise from wheel speed sensors 44 so as to minimize or otherwise ameliorate variances resulting from unwanted or extraneous variations in the sensor data that may not be directly related to actual motion or rotation of a sensed wheel. The noise filtering may be provided in an adaptive manner, optionally on a wheel-by-wheel basis, so as to increase and/or decrease levels of noise filtering as needed to compensate for variances that may be present or more pronounced at some wheel sensors 44 than others. The capability to filter out, attenuate, or otherwise compensate for the noise may be beneficial in providing more accurate and precise measurements, which may in turn be particularly valuable in optimizing operation of vehicle systems reliant upon or otherwise influenced by having suitable representations of wheel speed.

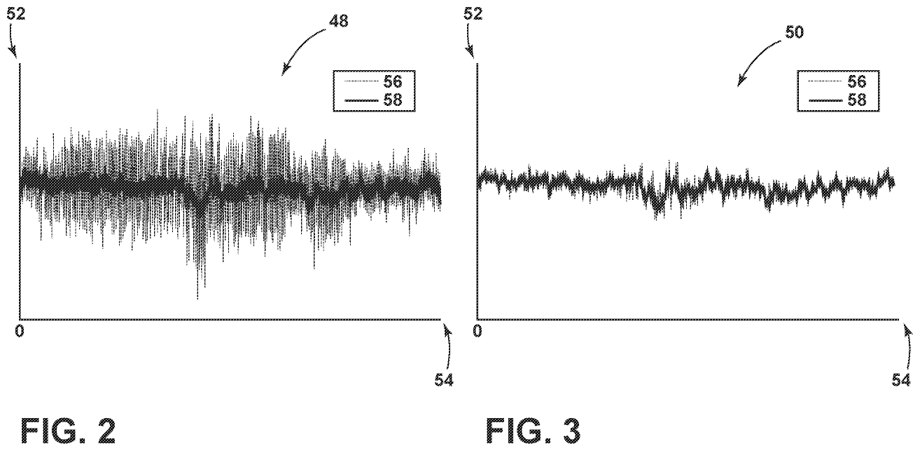

Due to differing road conditions, manufacturing variabilities, and other inherent or induced inconsistencies, the wheel speed sensors 44 may periodically provide differing or varying speed values, and in some cases, differing values when the wheels may be rotating at relatively the same speed. While contrasting road conditions, differing suppliers, inconsistent calibration, and other discrepancies may result in some of the wheels periodically rotating at differing speeds, one prevalent source of inconsistency may result from noise within sensor data collected with the wheel sensors 44, i.e., unwanted or extraneous variations in the sensor data that may not be directly related to actual motion or rotation of the attendant wheel. By way of example, FIGS. 2 and 3 provide an exemplary comparison of an unfiltered or raw wheel speed data graph 48 (FIG. 2) being filtered with the noise filter controller 42 to provide a filtered wheel speed sensor data graph 50 (FIG. 3) in accordance with the present disclosure. The graphs 48, 50 are presented for non-limiting purposes as representative of sensor data associated with the wheel sensors 44, however, as one skilled in the art may appreciate, the noise filtering described herein may be useful in facilitating noise filtering for other types of sensor data generated with other types of sensors 44 beside the wheel sensors 44. The graphs 48, 50 may each include a vertical axis 52 to represent wheel speed and a horizontal axis 54 to represent time, with each including a wheel speed data set 56 for a left front wheel and another wheel speed data set 58 for a right front wheel.

The filtered wheel speed data graph 50 is shown to include less variances in wheel speed relative to the unfiltered wheel speed data graph 48. This reduction in variances may be attributable to the noise filter controller 42 filtering out noise from the unfiltered wheel speed data. The minimization of noise may be beneficial in providing more accurate and precise representations of wheel speed, which may in turn be helpful in supporting a wide variety of vehicle systems (not show) reliant upon or otherwise influenced by having an accurate and precise representation of wheel speed. An advanced driving assistant system (ADAS), for example, may be one such system whereby its capability to operate as desired, e.g., to autonomously steer the vehicle in a straight line or along a desired path, may be improved by accurately and precisely adjusting the steering and other related controls according to actual variances in wheel speed, as opposed phantom variations in the sensor data resulting from noise. The capability of the noise filter controller 42 to filter out noise may be beneficial for a wide variety of other applications and purposes besides facilitating operation of the ADAS, e.g., the filtered sensor data may be used for updating sensing alignment criteria for robust parameter learn and better control performance and/or simplifying the complexity of calibration while also enhancing the robustness of dynamic bias learning/sensing alignment towards robust control features.

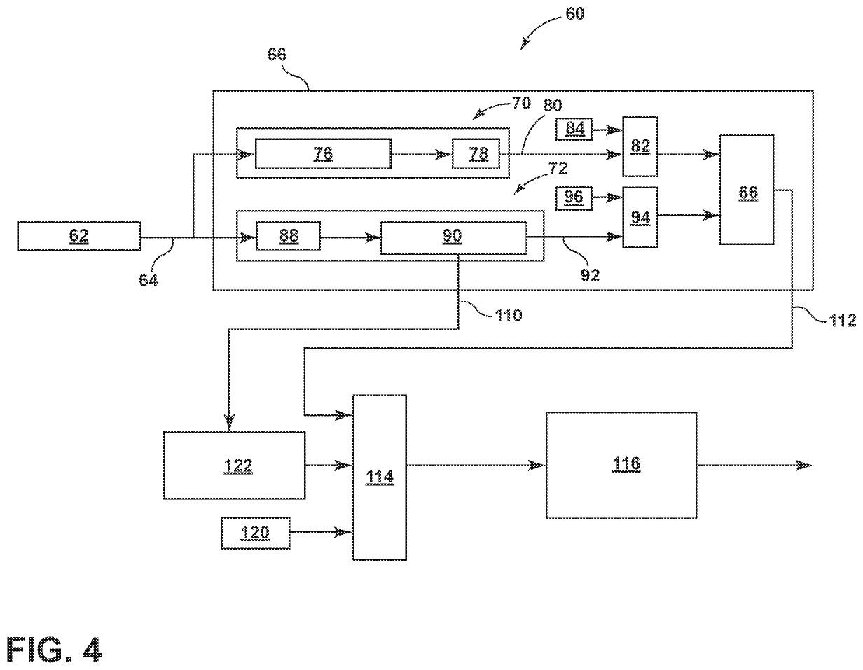

FIG. 4 illustrates a flowchart 60 of a method for filtering noise in accordance with one non-limiting aspect of the present disclosure. The method may be facilitated with the noise filter controller 42, and optionally the vehicle controller 38 and/or additional controllers included onboard and/or offboard the vehicle 12, operating according to one or more processors executing a corresponding plurality of non-transitory instructions stored on associated computer-readable storage medium. Block 62 relates to a data process for ascertaining sensor data 64 from the wheel speed sensors 44, which, for example, may be used for representing rotational speed of the wheel associated therewith. The sensor data 64 may be considered as raw or unfiltered data, such as a direct feed from the wheel sensors 44 comprised of values, data, and/or other information commensurate with that needed to produce the unfiltered wheel speed data graph of FIG. 2. The data process may include generating the sensor data 64 as independent data sets for each of the wheel sensors 44, with the noise filtering thereof being described for exemplary purposes with respect to filtering noise from one subset of the sensor data 64, i.e., the noise filter controller 42 may be operable for filtering noise simultaneously for multiple sets of the sensor data 64. As noted above, the noise filtering contemplated herein may be described with respect to wheel speed sensors 44, however, the present disclosure is not necessarily so limited and fully contemplates its use and application in filtering noise from other types of sensors 44.

Block 66 relates to a state determination process for characterizing a state of the unfiltered sensor data 64. The state determination may be employed to facilitate characterizing portions of the unfiltered sensor data 64 coinciding with a steady state of wheel operation and non-steady state of wheel operation. The steady state may correspond with a steady interval of wheel rotation, and the non-steady state may correspond with a non-steady interval of wheel rotation. The capability to distinguish portions of the unfiltered sensor data 64 corresponding with steady and non-steady states of wheel operation may be beneficial in adjusting the noise filtering to account for differing operating conditions, and in particular, to separating the noise filtering used to account for noise induced from transient or varying operating conditions, i.e., during non-steady states, relative to noise filtering used to account for noise induced from phantom variations in the sensor data 64 resulting from unwanted or extraneous variations in the sensor data 64 that may not be directly related to actual motion or rotation of the attendant wheel, i.e., during steady states. The differentiation between steady and non-steady states of operation is presented to highlight one beneficial aspect of the present disclosure in providing differing types of noise filtering, however, this is done for non-limiting purposes as the present disclosure fully contemplates performing the noise filtering without differentiating according to steady and non-steady state.

As described in more detail below, the differing types of noise filtering may correspond with adaptive filtering and non-adaptive filtering, optionally with the adaptive filtering corresponding with steady states of operation and the non-adaptive filtering corresponding with non-steady states of operation. One aspect of the present disclosure relates to performing a two-factor authentication process as art of the state determination process in Block 66 whereby the unfiltered sensor data 64 may be determined to be steady-state sensor data 64, i.e., sensor data 64 associated with the steady interval of wheel rotation, in the event the unfiltered sensor data 64 associated therewith surpasses the two-factor authentication process, and otherwise to be non-steady-state sensor data 64, i.e., sensor data 64 associated with the non-steady interval of wheel rotation. The two-factor authentication process may be used to assess speed variances within the unfiltered sensor data 64 to be within a steady range, i.e., within the steady interval or associated with the steady state, in response to the unfiltered sensor data 64 associated therewith separately passing both of a first aggregation assessment 70 and a second aggregation assessment 72. The first aggregation assessment 70 may be characterized as a shorter window aggregation assessment 70, and the second aggregation assessment 72 may be characterized as a longer window aggregation assessment 72.

The shorter aggregation assessment may include a stochastic filter 76 or other filter processing combined with an absolute value determination 78 whereby a short aggregation assessment 80 associated therewith may be output to a comparative process 82 for comparison to a corresponding coefficient or testing threshold 84. The shorter window aggregation assessment 70 may be considered as passed in response to the unfiltered sensor data 64 indicating the speed variances occurring throughout a shorter sampling window to be less than a first threshold specified in the testing threshold 84. The longer aggregation assessment 72 may include a buffer or the like 88 combined with a variability and/or noise characterization process 90 whereby a longer aggregation assessment 92 associated therewith may be output to a comparative process 94 for comparison to a corresponding coefficient or testing threshold 96. The longer window aggregation assessment 72 may be considered as passed in response to the unfiltered sensor data 64 indicating the speed variances occurring throughout a longer sampling window to be less than a second threshold specified in the testing threshold 96. The longer window aggregation assessment 72 may process the unfiltered sensor data 64 throughout a longer sampling window than a shorter sampling window of the shorter window aggregation assessment such that two-factor authentication is provided by sampling the unfiltered sensor data 64 across differing size sampling windows.

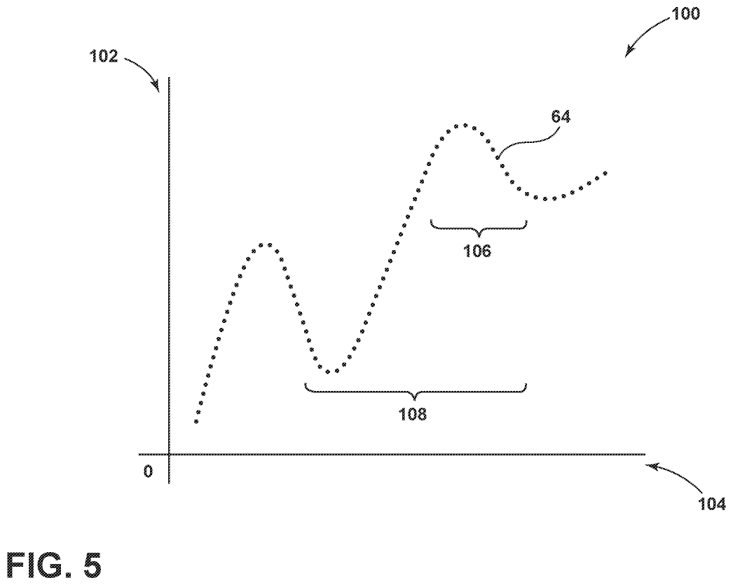

FIG. 5 illustrates a graph 100 of the unfiltered sensor data 64 relative to a vertical axis 102 representing wheel speed in a horizontal axis 104 representing time, with an exemplary callout 106 for the shorter sampling sized window in another callout 108 for the longer sampling sized window. The capability to assess the unfiltered sensor data 64 relative to differing size sampling windows and/or actually differing first and second thresholds, may be advantageous in robustly assessing whether the related unfiltered sensor data 64 corresponds with steady or non-steady intervals of wheel rotation. The variability process of the longer window aggregation assessment may include a variability calculation for characterizing an amount of noise within the unfiltered sensor data 64 according to a standard deviation or other statistical modeling thereof, optionally with a self-learning aspect whereby the variability process 90 may learn over time differing nuances of noise differences between the wheel sensors. The standard deviation or other statistical modeling may be used to generate a noise value 110 to represent the amount of noise within the unfiltered sensor data 64 associated therewith, which as described below in more detail, may be utilized in concert with a two-factor output 112 of the two-factor authentication process to facilitate a filtering selection process show in Block 114. The filter selection process may cooperate with a filtering process shown in Block 116 to facilitate selectively filtering the unfiltered sensor data 64 into unfiltered sensor data 64 operable with various systems onboard and/or offboard the vehicle 12. One aspect of the present disclosure contemplates the filter selection process including making a determination to adaptively and/or non-adaptively filter the unfiltered sensor data 64.

The filtering process may include filtering noise from the sensor data 64 associated with the non-steady intervals according to a non-adaptive filtering process, such as with a static filter selected from a plurality of speed based filters. A static filter selection process in Block 120 may include selecting the static filter from a look-up table configured for cross-referencing the speed based filters relative to a vehicle speed of the vehicle. The static filter may correspond with a one of the speed based filters most closely aligned with the wheel or vehicle speed associated with the sensor data 64 being filtered. The selection of the static filter based on the speed may be useful in tailoring the filtering according to predefined or predetermined filters tested to be operable for accounting for noise induced from transient or varying operating conditions, i.e., during non-steady states while the wheel is operating. The filtering process may include filtering noise from the unfiltered sensor data 64 associated with the steady intervals according to an adaptive filtering process, such as with a noise filter selected from a plurality of possible noise filters. An adaptive filter selection process in Block 122 may include selecting the noise filter based on the noise value 110 determined in the variability calculation of Block 90 such that the noise filter is selected based additionally on an amount of noise within the unfiltered data and not just wheel speed or speed of the vehicle.

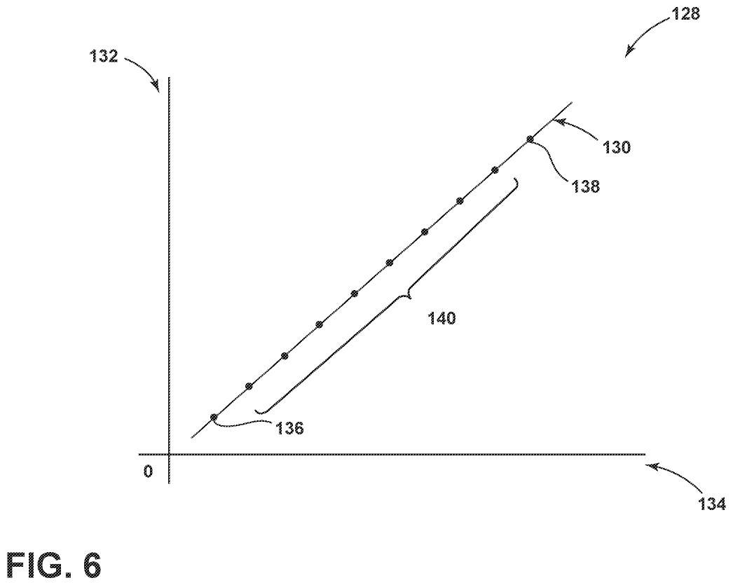

The adaptive filter selection process may include a filter analysis process operable for cross-referencing the noise value 110, i.e., the standard deviation or other statistical representation of the amount of noise in the unfiltered sensor data 64 having passed the two-factor authentication process, relative to a filter selection feature to determine the noise filter to be used for the adaptive filtering process. The filter selection feature may be operable for delineating the available filters relative to a plurality of possible noise values. FIG. 6 illustrates a filter selection graph 128 in accordance with one non-limiting aspect of the present disclosure. The filter selection graph 128 may correspond with a selection feature operable for delineating a plurality of possible noise filters available for the adaptive filtering process being referenced relative to a filter line 130, with the filter line 130 being defined relative to a vertical axis 132 representative of filtering coefficient and/or other selectable range of possible filter values and a horizontal axis 134 representative of possible noise values. While other filter lines 130 may be utilized, the filter line 130 is shown to delineate a linear dispersion of the filtering coefficients, which generally extends in a linear manner from a lowest coefficient 136 for a lowest amount of noise and a greatest coefficient 138 for a greatest amount of noise with a plurality of intermediary coefficients 140 therebetween.

The filter coefficients selected for the adaptive filtering may correspond with a related one of the possible noise values closely aligned with the noise value 110. One aspect of the present disclosure contemplates the available noise filters corresponding with a plurality of low-pass filters arranged in the filter selection graph 128 such that a lowest frequency filter 136 of the low-pass filters corresponds with a lowest one of the possible noise values and a highest frequency filter 138 of the low-pass filters corresponds with a highest one of the possible noise values. The use of low-pass filters, in particular the low-pass filters selected based on frequency, is presented for non-limiting purposes as the present disclosure fully contemplates selecting and/or defining the noise filters according to a wide range of filtering values, coefficients, etc. The noise filters, for example, may be adaptive based on the noise value 110 to facilitate implementing the adaptive filtering process according to selectable alterations made to cutoff frequency, filter order, time constant, adaptation step size, filter initialization parameters, weighting factors, window size, adaptive smoothing parameters, converging criteria, etc.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A method of filtering noise for a wheel speed sensor, the wheel speed sensor configured for sensing rotational speed of a wheel included onboard a vehicle, the method comprising:
determining sensor data generated with the wheel speed sensor, the sensor data representing rotational speed of the wheel;
determining a steady interval of wheel rotation and a non-steady interval of wheel rotation, the steady interval corresponding with the wheel rotating at a steady state, the non-steady interval corresponding with the wheel rotating at a non-steady state; and
filtering noise from the sensor data associated with the steady interval according to an adaptive filtering process.

2. The method according to claim 1, further comprising:
performing the adaptive filtering process based on a variability calculation, the variability calculation generating a noise value to represent an amount of noise within the sensor data associated therewith.

3. The method according to claim 2, further comprising:
performing a filter selection process to select a noise filter for the adaptive filtering process from a plurality of available filters, including selecting the noise filter based on the noise value.

4. The method according to claim 3, further comprising:
the filter selection process including cross-referencing the noise value relative to a filter selection graph to determine the noise filter, the filter selection graph delineating the available filters relative to a plurality of possible noise values.

5. The method according to claim 4, further comprising:
selecting the noise filter to correspond with a one of the available filters cross-referenced with a related one of the possible noise values most closely aligned with the noise value.

6. The method according to claim 5, further comprising:
the available filters corresponding with a plurality of low-pass filters arranged in the filter selection graph such that a lowest frequency filter of the low-pass filters corresponds with a lowest one of the possible noise values and a highest frequency filter of the low-pass filters corresponds with a highest one of the possible noise values.

7. The method according to claim 6, further comprising:
the available filters in the filter graph being dispersed in a linear manner between the lowest frequency filter and the highest frequency filter.

8. The method according to claim 1, further comprising:
filtering noise from the sensor data associated with the non-steady interval according to a non-adaptive filtering process, the non-adaptive filtering process including filtering noise from the sensor data using a static filter.

9. The method according to claim 8, further comprising:
selecting the static filter from a look-up table configured for cross-referencing a plurality of speed based filters relative to a vehicle speed of the vehicle, the static filter corresponding with a one of the speed based filters most closely aligned with the vehicle speed associated with the sensor data being filtered.

10. The method according to claim 1, further comprising:
determining the steady and non-steady intervals according to a variability process, the variability processing determining the steady interval to coincide with the sensor data indicating speed variances in the wheel rotation to be within a steady range.

11. The method according to claim 10, further comprising:
determining the wheel rotation to be within the steady range based on a two-factor authentication process, the two-factor authentication process assessing the speed variances to be within the steady range in response to the sensor data associated therewith separately passing both of a shorter window aggregation assessment and a longer window aggregation assessment.

12. The method according to claim 11, further comprising:
determining the shorter window aggregation assessment to be passed in response to the sensor data indicating the speed variances occurring throughout a shorter sampling window to be less than a first threshold.

13. The method according to claim 12, further comprising:
determining the longer window aggregation assessment to be passed in response to the sensor data indicating the speed variances occurring throughout a longer sampling window to be less than a second threshold, wherein the longer sampling window is larger than the shorter sampling window.

14. A computer-readable storage medium having a plurality of non-transitory instructions stored thereon, which, when executed with one or more processors, are operable for filtering noise of a wheel speed sensor configured for sensing rotational speed of a wheel included onboard a vehicle, wherein the non-transitory instructions are operable for:
determining sensor data generated with the wheel speed sensor, the sensor data representing rotational speed of the wheel;
determining a steady interval of wheel rotation and a non-steady interval of wheel rotation, the steady interval corresponding with the wheel rotating at a steady state, the non-steady interval corresponding with the wheel rotating at a non-steady state;
characterizing the sensor data associated with the steady interval as steady-state sensor data and the sensor data associated with the non-steady interval as non-steady-state sensor data;
generating a steady-state noise characterization for the steady-state sensor data;
selecting a noise filter from a plurality of available filters based on the steady-state noise characterization; and
filtering noise from the steady-state sensor data according to an adaptive filtering process.

15. The computer-readable storage medium according to claim 14, wherein the non-transitory instructions are operable for:
determining the steady-state noise characterization based on a variability calculation configured for characterizing an amount of noise within the sensor data according to a standard deviation thereof.

16. The computer-readable storage medium according to claim 15, wherein the non-transitory instructions are operable for:
selecting the noise filter from a filter selection graph configured for delineating the available filters relative to a plurality of possible steady-state noise characterizations, including selecting the noise filter to correspond with the available filter cross-referenced with the steady-state noise characterization most closely aligned with the standard deviation.

17. The computer-readable storage medium according to claim 16, wherein the non-transitory instructions are operable for:
selecting the noise filter to correspond with one of a plurality of low-pass filters arranged in the filter selection graph in a linear manner from a lowest frequency low-pass filter to a highest frequency low-pass filter with a plurality of intermediary low-pass filters therebetween.

18. A vehicle, comprising:
a plurality of wheels operable to facilitate movement of the vehicle;
a powertrain operable to rotate one or more of the wheels in response to mechanical power generated with an internal combustion engine and/or an electric motor;
a plurality of wheel sensors operable for sensing rotational speed of a corresponding one of the wheels, the wheel sensors configured for generating sensor data to represent the rotational speed of the wheel associated therewith; and
a noise filter controller configured for adaptively filtering noise from the sensor data using a noise filter individually selected for each of the wheel sensors from a plurality of available filters, wherein the noise filter controller is configured for selecting the noise filters based on a noise characterization for the wheel sensor associated therewith.

19. The vehicle according to claim 18, wherein:
the available filters include a plurality of low-pass filters configured for low-pass filtering according to differing ones of a plurality of filter frequencies; and
the noise filter control is configured for selecting the noise filters to correspond with the low-pass filter most closely aligned with the noise characterization of the wheel sensor associated therewith.

20. The vehicle according to claim 19, wherein:
the low-pass filters are arranged in a filter selection graph in a linear manner relative to the noise characterizations from a lowest frequency low-pass filter to a highest frequency low-pass filter with a plurality of intermediary low-pass filters therebetween.
